(19) United States
(12) Patent Application Publication
(10) Pub. No.: US 2012/0151559 A1
(43) Pub. Date: Jun. 14, 2012

(54) Threat Detection in a Data Processing System

(75) Inventors: Joshua Koudys, Richmond Hill (CA); Andres H. Voldman, Markham (CA)

(73) Assignee: INTERNATIONAL BUSINESS MACHINES CORPORATION, Armonk, NY (US)

(21) Appl. No.: 13/391,677

(22) PCT Filed: Aug. 23, 2010
(86) PCT No.: PCT/EP2010/062273

§ 371 Date: Feb. 22, 2012

(30) Foreign Application Priority Data
Aug. 28, 2009 (CA) 2675664

(51) Int. Cl. H04L 9/32

(52) U.S. Cl. 726/3; 726/23

(57) ABSTRACT

A mechanism is provided for resolving a detected threat. A request is received from a requester to form a received request, statistics associated with the received request are extracted to form extracted statistics, rules validation is performed for the received request using the extracted statistics, and a determination is made as to whether the request is a threat. Responsive to a determination that the request is a threat, the requester is escalated using escalation increments, where the using escalation increments further comprises increasing user identity and validation requirements through one of percolate to a next user level or direct entry to a user level.

### BACKGROUND

The present application relates generally to an improved data processing apparatus and method and more specifically to mechanisms for threat detection in a data processing system.

Web applications may be deliberately or accidentally exposed to misuse and attacks. Application level attacks, for example, denial of service (DoS), brute force or exploitation of unbounded conditions impact a business by limiting the availability and the integrity of the application. Identifying a problem and deploying a solution can be very time consuming. While the problem exists, the application continues to be unavailable typically leading to a loss of revenue. Alternatively, limiting access to the application is ineffective because the offending agent can easily change locations, and any blocks put in place at the network layer can potentially affect a large percentage of the valid user community of the application.

Typical solutions target the network layer when suspicious activity occurs. However as previously stated, application level attacks are often unintentional. Frequently, web crawlers, also known as robots or simply bots, business partners, or users engaging in unusual, but not malicious, behavior, cause the application level attacks. Having more information about the attacker, who often is willing to disclose such data, can be critical in problem resolution.

### SUMMARY

In one illustrative embodiment, a method, in a data processing system, is provided for resolving a detected threat. The illustrative embodiment receives a request from a requester to form a received request, extracts statistics associated with the received request to form extracted statistics, performs rules validation for the received request using the extracted statistics, and determines whether the requester is a threat. Responsive to a determination that the requester is a threat, the illustrative embodiment escalates the requester using escalation increments. In the illustrative embodiment, using escalation increments further comprises increasing user identity and validation requirements through one of percolate to a next user level or direct entry to a user level.

In other illustrative embodiments, a computer program product comprising a computer useable or readable medium having a computer executable program code is provided. The computer executable program code, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system operable for various embodiments of the disclosure;

FIG. 2 is a flowchart of an anomaly based application intrusion detection system, in accordance with various embodiments of the disclosure;

FIG. 3 is a block diagram of escalation increments and user levels used with the anomaly based application intrusion detection system of FIG. 2, in accordance with one embodiment of the disclosure;

FIG. 4 is a flowchart of a blocking process using the user levels of FIG. 3, in accordance with one embodiment of the disclosure;

FIG. 5a is a flowchart of an escalate process of FIG. 4, in accordance with one embodiment of the disclosure; and

FIG. 5b is a flowchart of a verification process of FIG. 5a, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product tangibly embodied in any medium of expression with computer usable program code embodied in the medium.

Computer program code for carrying out operations of the present disclosure may be written in any combination of one or more programming languages, including an object oriented programming language such as Java™, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

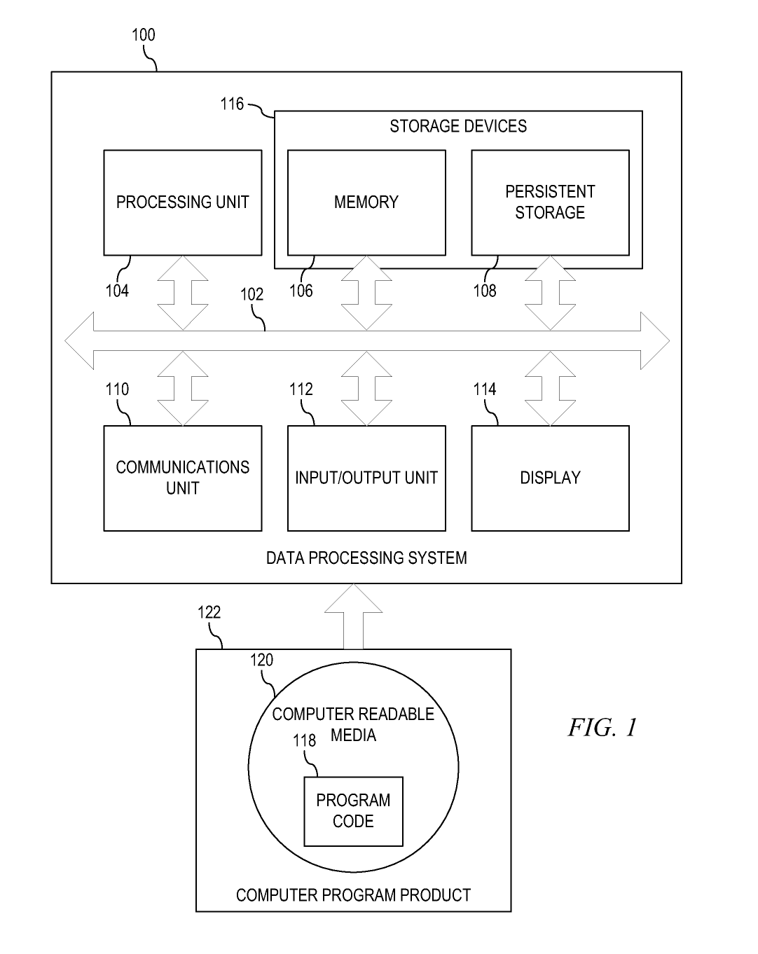

Turning now to FIG. 1 a block diagram of an exemplary data processing system operable for various embodiments of the disclosure is presented. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable media 120 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 may be any hardware apparatus that may store data. Memory 106, persistent storage 108 and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

According to an illustrative embodiment, a computer-implemented process for resolving a detected threat is presented. The computer-implemented process receives a request from a requester to form a received request, extracts statistics associated with the received request to form extracted statistics, performs rules validation for the received request using the extracted statistics, and determines whether the requester is a threat. Responsive to a determination that the requester is a threat, escalate the requester using escalation increments, wherein escalate further comprises percolate to a next user level or direct entry to a user level.

Using data processing system 100 of FIG. 1 as an example, an illustrative embodiment provides the computer-implemented process stored in memory 106, executed by processor unit 104, receives a request from a requester to form a received request, for example, through communications unit 110, or input/output unit 112. Processor unit 104 extracts statistics associated with the received request to form extracted statistics that may be stored in storage devices 116. Processor unit 104, performs rules validation for the received request using the extracted statistics, and determines whether the requester is a threat. Responsive to a determination that the requester is a threat, processor unit 104 escalates the requester using escalation increments, that may be stored within memory 106, or persistent storage 108, wherein escalate further comprises percolate to a next user level or direct entry to a user level. Escalation typically involves increasing user identity and validation requirements.

In an alternative embodiment, program code 118 containing the computer-implemented process may be stored within computer readable media 120 as computer program product 122. In another illustrative embodiment, the process for access control by trust assertion using hierarchical weights, may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

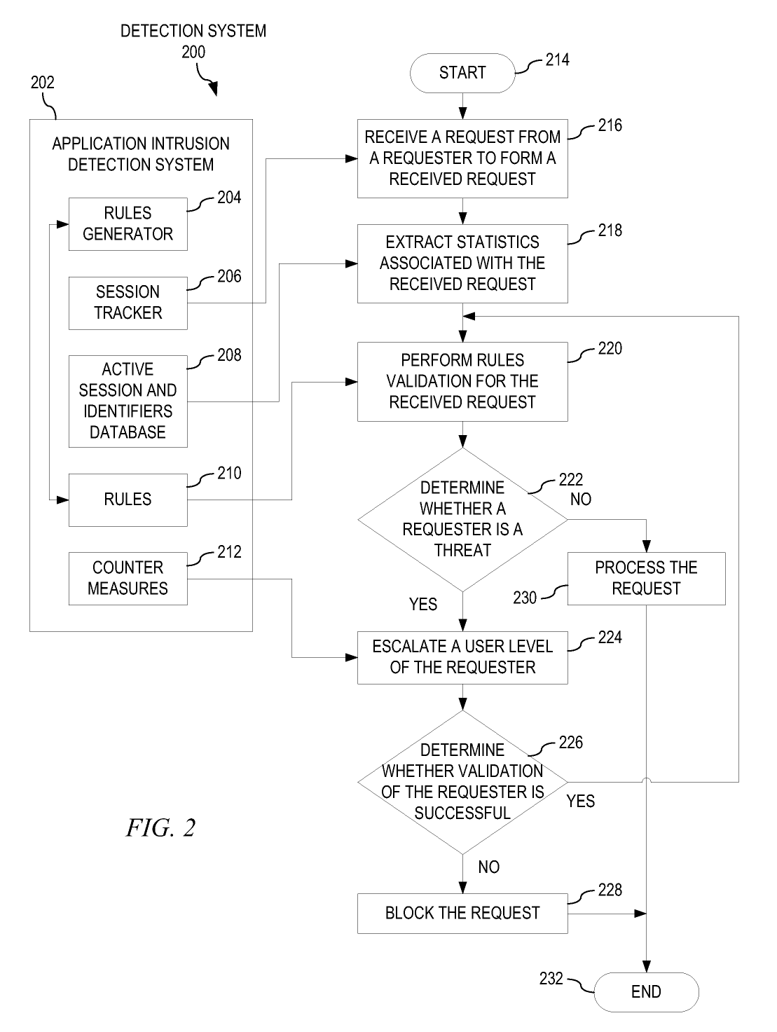

With reference to FIG. 2, a flowchart of an anomaly based application intrusion detection system, in accordance with various embodiments of the disclosure is presented. Detection system 200 is an example of an anomaly based application intrusion detection system provided with a capability to escalate user levels incrementally. Detection system 200 may be based on a new or existing anomaly based application level intrusion detention system, for example anomaly based application intrusion detection system 202.

A typical anomaly based application intrusion detection system (APIDS) may be represented by anomaly based application intrusion detection system 202. For example, anomaly based application intrusion detection system 202 includes a number of components including rules generator 204, session tracker 206, active session and identifiers database 208, rules 210 and countermeasures 212.

Rules generator 204 is a component that uses information obtained in differing formats including manual input, usage history, forecasts and usage exceptions to define a variable baseline of use and to generate rules. Rules are used to establish conformance criteria against which requests of receive a request from a requester to form a received request 216 can be measured in a process started in operation 214. For example, when using a website, rules generator 204 may include a capability for, but is not limited to, criteria related to page distribution, response times, number of hits per session and previous and next pages.

Session tracker 206 is a component with a capability to track user interactions with a system. This component typically includes a secure session identification mechanism, for example, an encrypted cookie for web applications associated with receiving a request from a requester to form a received request 216.

Active session and identifiers database 208 is an example of a component that works in conjunction with the session tracker 206 to collect usage statistics for active sessions and associated identifiers. For example, identifiers can include a request location in the form of Internet protocol address or user agent identification. Extract statistics associated with the received request 218 may be performed to provide collection of information related to a session of request obtained in receive a request from a requester to form a received request 216 for storage. If the anomaly based application intrusion detection system 202 has previously detected this requester as a threat, extra statistics may be extracted during the operation of extract statistics associated with the received request 218.

Rules 210 is an example of a component with a capability to compare the statistics or properties of incoming requests and associated identifiers to the existing rules as in performing rules validation for the received request 220. A selection of rules for the specific user level being used is performed to identify the relevant rules. When a request is obtained, a comparison is performed against a predefined criterion by perform rules validation for the received request 220. A determination is made as to whether the request meets a predefined threshold as in determine whether a requester is a threat 222. When the comparison fails to meet the threshold, the request is marked as being suspicious as in escalating a user level of the requester 224. Suspicious requests are typically known as threats. Escalation of a suspicious request creates a new request used to determine whether validation of the requester is successful 226. When the determination yields a successful result, rules validation for the received request is performed 220 followed by determining whether the requester is a threat 222 again. When there is no threat, processing the request 230 is performed with the process ending at end 232.

Countermeasures 212 is an example of a component that is capable of reacting to identified threats within the system. Countermeasures 212 represent an example of a location where escalations of user identify and validation requirements may occur. For example, a countermeasure is presented as block the request 228 with the process ending at end 232. In another example, a challenge-response test most often placed within web forms to determine whether the user is human and collect verification information may also be a countermeasure presented to a suspected attacker or suspicious user.

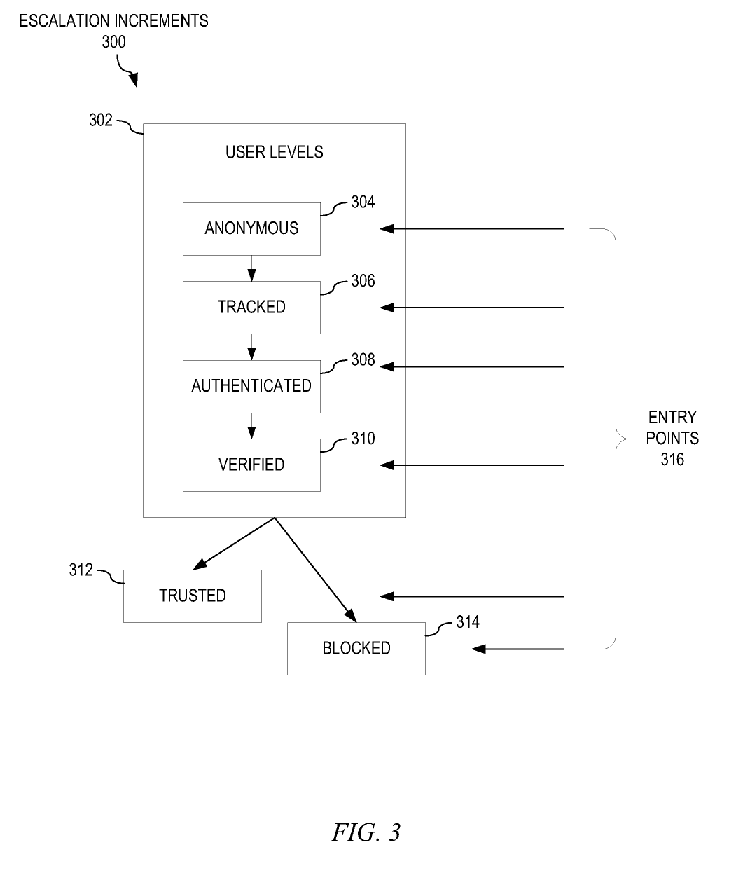

With reference to FIG. 3, a block diagram of escalation increments and user levels used with the anomaly based application intrusion detection system of FIG. 2, in accordance with one embodiment of the disclosure is presented. Escalation increments 300 is an example of a system comprising different levels of escalation in which each level requires different and more specific user information than a previous level.

Detection system 200 of FIG. 2, detects which levels, with incremental requirements for user information disclosure and user validation, are required. When a threat or anomaly is detected, the user is forcefully escalated to the next level. Escalation to a next level includes increasing user identity and validation requirements. Countering application level attacks by escalation of user identity and validation requirements has multiple benefits including forcing the attacker to disclose more information about the attacker. The added information typically reduces the time needed to identify an attacker. Because many application level attacks are unintentional, a process using escalation increments 300 may effectively reveal the identity of the attacker. Impact to other users of the application may be minimized because the validation process is non-intrusive and integrated with the application. Use of escalation increments 300 provides a capability to programmatically detect and block unauthorized access by robots or non-human agents.

The user levels are typically separated into categories or user levels 302 of anonymous 304, tracked 306, authenticated 308, verified 310, trusted 312 and blocked 314. Anonymous 304 is a category associated with requests in which the user does not provide any specific information about the user. For example, if this is the first request to a website. Anonymous requests are escalated to a category of tracked 306. If the requests belong to a suspicious group, such as known malicious location associated with a specific Internet protocol address, or user agent, the request is escalated to a user level of authenticate 308.

Tracked 306 represents requests that belong to a session being securely tracked at the server layer. The tracking allows the detection system to detect anomalies, such as brute force or denial of service attacks, in the way in which a specific agent uses the application.

Authenticated 308 represents a next higher level from tracked 306 used when an anomaly is discovered for a tracked request, and the agent will be forced to authenticate. Authentication typically requires redirection to a logon page where the user is required to provide an identity and to enter a password. The logon page would usually be obfuscated to prevent automatic logon from robots or other automated users. As another example, if the user is not registered with the system, the system may provide an option to register and authenticate the user at this point in time. The system can perform a validation and ensure that the registration information for the agent is complete. The registration process may also require asking a human user to provide an updated telephone number or email address to the system.

Verified 310 represents a level above authenticated 308 used when an anomaly is discovered for an authenticated request. In this case, the user is escalated to the verified level. Verified 310 typically involves the use of human validation tools or engaging an administrator or a customer service representative to verify the user. The tools ensure the presenting user is not an automated mechanism such as a scripted robot, and that the user currently accessing this account is, or is trusted by, the person who originally registered this account.

Trusted 312 represents a user level in which a trusted user is a user for which the application administrator has generated an exception to always be trusted. Trusted users may exist at all levels, for example, a user may be trusted as an anonymous user coming from a trusted Internet protocol address associated with a trusted robot, or an administrator account.

Blocked 314 represents a user level in which a user is prevented from further action. Like trusted 312, a user is set to blocked by an administrative action, which may or may not be automated. Typically, blocking will be in response to a user submitting requests that are determined to be threats. For example, when a set of Internet protocol addresses is repeatedly used to attack a site all users belonging to those addresses will be blocked. A level may escalate up, or at any time be set to a level of trusted or a level of blocked. Upward escalation follows a path through the hierarchy while setting to a specific level uses entry points 316 for direct access.

Security associated with the different user levels determines a process path. Trusted user levels are immediately processed. When a user is blocked, the request associated with the user is blocked. Anonymous users are immediately escalated to a tracked level to provide additional information. All other users will be escalated to a next higher level when they are perceived as a threat. A user may be given multiple chances to escalate before a blocking action is taken. The terms or severity of a block action are at the discretion of the administrator or an installation defined policy.

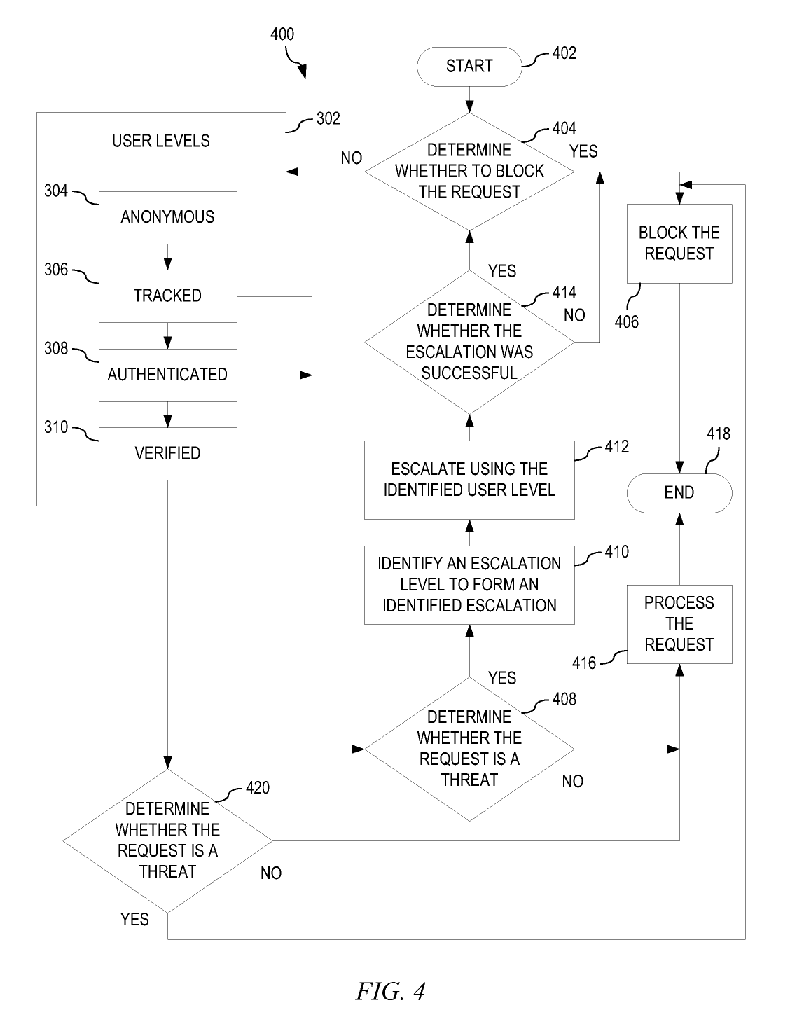

With reference to FIG. 4, a flowchart of a blocking process using the user levels of escalation increments of FIG. 3, in accordance with one embodiment of the disclosure is presented. Process 400 is an example of a user blocking process using escalation increments 300 with user levels 302 of FIG. 3.

Process 400 starts (step 402) and determines whether to block the request (step 404). When a determination is made that the request is not blocked, a “no” response is obtained. When a determination is made to block the request a “yes” response is obtained. When a “no” is obtained in step 404, user levels 302 is set to anonymous 304 in this example. The user is automatically escalated to tracked 306. When a “yes” result is obtained in step 404, a blocking action is necessary and block the request is performed (step 406) with process 400 terminating thereafter (step 418).

Process 400 determines whether the request is a threat (step 408). A determination may be performed based on a comparison of tracked information for this user, or type of user, with previously stored information. The comparison of the tracked information is based on comparing predefined criteria associated with a user level of an escalation increment. When a determination is made that the requesting user or request is a threat, a “yes” is obtained. When a determination is made that the requesting user or request is not a threat, a “no” result is obtained. When a “no” result is obtained in step 408, no threat is perceived and the user request is performed in process the request (step 416) with process 400 terminating thereafter (step 418). For example, when a tracked user is shopping at an on-line store, and the user attempts to buy an abnormally high number of items, the action would trigger in a “threat” result.

When a “yes” is obtained in step 408, identify an escalation increment to form an identified escalation is performed (step 410). Selection of an escalation increment may be made according to a next level in the user level hierarchy or by installation defined policies. For example, a default setting may allow user levels to percolate upward. In another example, a policy may require failed authentication to result in setting the user request to block based on a given situation. Escalation typically involves increasing user identity and validation requirements.

Escalate using the identified escalation increment is performed (step 412). The escalation performed depends upon the settings assigned to the respective user level as determined by an installation or user administrator specification or selection. Determine whether the escalation was successful (step 414). When a determination is made that the escalation was successful, a “yes” result is obtained in step 414. When a determination is made that the escalation was not successful, a “no” result is obtained in step 414. When a “yes” result is obtained in step 414, process 400 loops back to step 404 where the user request is re-evaluated.

However, when a “no” result is obtained in step 414, the escalation was not successful and action to block the request is performed (step 406) with process 400 terminating thereafter (step 418).

When a request is escalated or set to a user level of verified 310, a determination is made as to whether the request is a threat (step 420). When a determination is made that the request is a threat, a “yes” result is obtained. When a determination is made that the request is not a threat, a “no” result is obtained. When a “no” result is obtained in step 420, no threat is perceived and the user request is performed in process the request step 416 with process 400 terminating thereafter in step 418 as before. When a “yes” result is obtained a blocking action is performed in block the request 406 with process 400 terminating thereafter in step 418 as before.

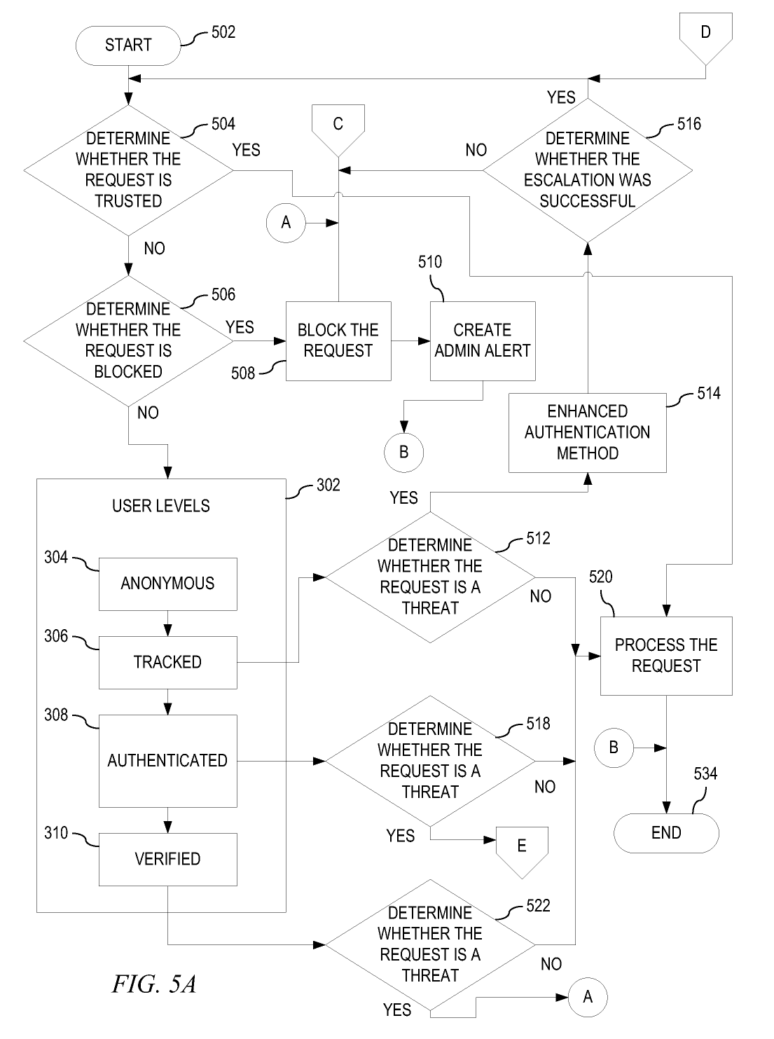

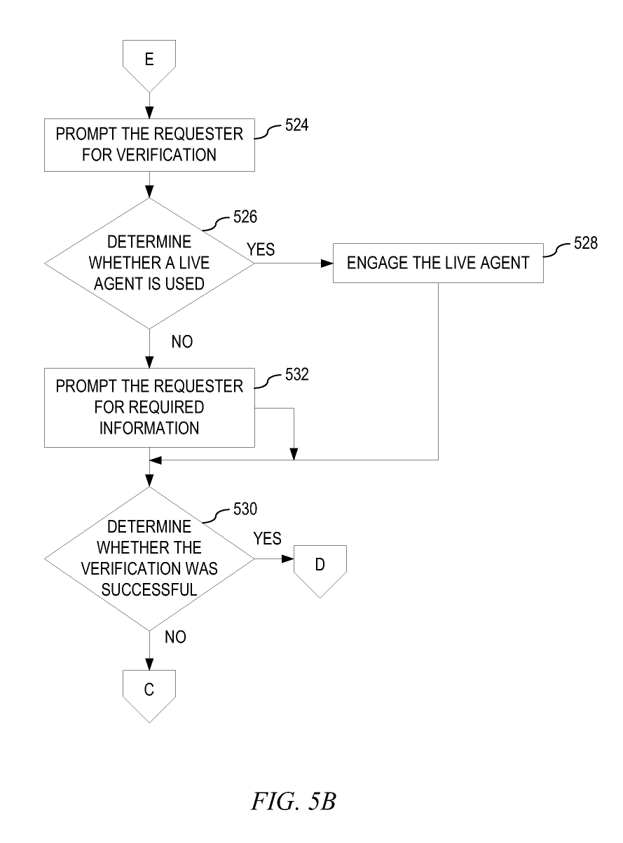

With reference to FIG. 5a, a flowchart of an escalate process of FIG. 4 in accordance with one embodiment of the disclosure is presented. Process 500 is an example of an escalate process in combination with a verification process. For example, escalate the user level using the identified escalation increment 412 of FIG. 4 and details of verification typically performed.

Process 500 starts (step 502) and determines whether the request is trusted (step 504). When a determination is made that the request is trusted a “yes” result is obtained. When a determination is made that the request is not trusted, a “no” result is obtained. When a “yes” is obtained in step 504, perform the request is performed (step 520) with process 500 terminating thereafter (step 534).

When a “no” result is obtained in step 504, determine whether the request is blocked (step 506). A “yes” result is obtained when a determination is made that the request is to be blocked. A “no” result is obtained when a determination is made that the request is not blocked. When a “yes” result is obtained block the user request is performed (step 508). Create admin alert is performed (step 510), with process 500 terminating thereafter (step 534). Creation of the admin alert logs the blocking action information. For example, an administrator or an automated process could use the admin alert log to set this user involved in the alert to a level of blocked 314 of FIG. 3.

When a “no” result is obtained in step 506 escalation using user levels 302 of FIG. 3 occurs. When an entry at anonymous 304 of user levels 302 of FIG. 3 occurs, automatic escalation to tracked 306 of FIG. 3 occurs. Upon tracking, determine whether the request is a threat is performed (step 512). When a determination is made that the request is a threat, a “yes” is obtained. When a determination is made that there is no threat associated with the request, a “no” is obtained. When a “yes” is obtained in step 512, enhanced authentication method is performed (step 514). The escalation process may include further processing of the information gathered during the tracking of the session associated with the request. For example, a user may be required to log in at this point, and pass a completely automated Turing test to tell computers and humans apart (CAPTCHA), or a set of security questions to prove the user is a human user, or to answer a set of security questions to support the user identity. When a “yes” is obtained in step 512, process the request in step 520 is performed as before, with process 500 terminating thereafter (step 534).

Determine whether the escalation was successful is performed (step 516). A determination that the escalation was successful provides a “yes” result. A determination that the escalation was not successful provides a “no” result. When a “no” result is obtained in step 516, process 500 loops back to perform block the request (step 508) as before. When a “yes” is obtained in step 516, process 500 loops back to re-evaluate the request and step 502 is performed as before.

When an entry at authenticated 308 of user levels 302 of FIG. 3 occurs, determine whether the request is a threat is performed (step 518). When a determination is made that there is a threat, a “yes” result is obtained. When a determination is made that there is not a threat, a “no” result is obtained. When a “no” is obtained in step 518, process the request in step 520 is performed as before, with process 500 terminating thereafter (step 534). When a “yes” is obtained in step 518, process 500 skips to step 524 described in the following section and as shown in FIG. 5b.

When an entry at verified 310 of user levels 302 of FIG. 3 occurs, determine whether the request is a threat is performed (step 522). When a determination is made that there is a threat, a “yes” result is obtained. When a determination is made that there is not a threat, a “no” result is obtained. When a “no” is obtained in step 522, process the request in step 520 is performed as before, with process 500 terminating thereafter (step 534). When a “yes” is obtained in step 522, process 500 loops back to block the request step 508. As before, create admin alert is performed (step 510) with process 500 terminating thereafter (step 534).

With reference now to FIG. 5b, a flowchart of a verification process of FIG. 5a is presented. When a determination is made that there is a threat, and a “yes” result is obtained is obtained in step 518, prompt the requester for verification is performed (step 524). Information is required from the requester to assist in determining whether the request should be performed. Information could be personal or business related information unique to the requester or a form of privileged information known to the requester. For example, the information may include account codes, birth dates, employee identifiers and access codes. A prompt may also include an operation to determine whether a live agent is used (step 526). The live agent may be in the form of a chat session or a telephone conversation. When a determination is made to use a live agent a “yes” result is obtained. When a determination is made to not use a live agent a “no” result is obtained.

When a “yes” is obtained in step 526, engage the live agent is performed (step 528). The agent proceeds to have a dialogue with the requester to obtained necessary information to permit the request to proceed. Determine whether the verification was successful occurs (step 530). When a determination is made that the verification is successful a “yes” result occurs. When a determination is made that the verification is not successful a “no” result occurs.

When a “yes” is obtained in step 530, process loops back to re-evaluate the request in step 502 as before. When a “no” is obtained in step 530, process 500 loops back to block the request in step 508 as before. Process 500 then creates admin alert (step 510) terminating thereafter (step 534).

When a “no” is obtained in step 526, prompt the requester for required information is performed (step 532). Here the requester is required to enter the missing information to be used to further verify the request before the request may be processed. The user must respond with the required information. For example, a panel may be presented to the requester with highlighted entry fields. Input must be provided by the requester and verified to allow the request to be processed. Determine whether the verification is successful is performed (step 530) as before.

Illustrative embodiments thus provide a process, a computer program product and an apparatus for resolving a detected threat by escalation of user identity and validation requirements. One illustrative embodiment provides a computer-implemented process for resolving a detected threat by receiving a request from a requester to form a received request and extracting statistics associated with the received request to form extracted statistics. Rules validation for the received request is performed using the extracted statistics and responsive to a determination that the request is a threat, the requester is escalated using escalation increments, wherein the using escalation increments further comprises increasing user identity and validation requirements through one of percolating to a next user level and direct entry to a user level.

For example, an illustrative embodiment may be used in a situation where robot agent causes excessive traffic against a web site. A business partner may be trying to extract catalog information, having implemented a robot to scan the site and add each product to a shopping cart to obtain pricing information. Calculating prices is a resource intensive operation. Executing the pricing operation thousands of times in a short interval will cause a service outage if not detected and managed. Using the described process, the business partner would be forced to authenticate, and the site administrator would then be aware of who was creating the problem. The verification process would have prevented the robot agent from working, so the business partner may have noticed and decided to contact the administrator on his own accord.

In another example, a business user tried creating a shopping cart that included hundreds of items. The store did not have a fixed limit to the maximum number of items allowed in a shopping cart. The shopping cart requires a large memory footprint that creates an out-of-memory condition. An illustrative embodiment would have forced the user to login once the anomalous behavior had been detected. During the verification escalation, a customer support representative may have engaged the user.

In another example using an illustrative embodiment as just described, a user deliberately attacks a web site using a high-impact application function such as a registration function. A malicious user creates thousands of user registration requests, after noticing that this requires a long time for the application to process. The user repeatedly discards his old sessions to create a deliberate attack. An illustrative embodiment as just described would have blocked the anonymous user, by identifying the user group from the Internet protocol address of specific user agent associated with the attack.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system comprising a processor and a memory coupled to the processor, for resolving a detected threat, the method comprising:
receiving, by the processor, a request from a requester to form a received request;
extracting, by the processor, statistics associated with the received request to form extracted statistics;
performing, by the processor rules validation for the received request using the extracted statistics;
determining, by the processor, whether the request is a threat; and
responsive to a determination that the request is a threat, escalating, by the processor, the requester using escalation increments, wherein the using escalation increments further comprises increasing user identity and validation requirements through one of percolating to a next user level and direct entry to a user level.

2. The method of claim 1, wherein extracting statistics associated with the received request further comprises:
tracking, by the processor, session information to form tracked session information; and
storing, by the processor, the tracked session information in an active session and identifiers database.

3. The method of claim 1, wherein performing rules validation further comprises:
selecting, by the processor, rules associated with an escalation increment to form selected rules; and
applying, by the processor, the selected rules to the received request.

4. The method of claim 2, wherein determining whether the request is a threat further comprises:
comparing, by the processor, the tracked session information with predefined criteria associated with a user level of an escalation increment to form a comparison; and
determining, by the processor, whether the comparison exceeds a predefined threshold.

5. The method of claim 1, wherein escalating the requester using escalation increments further comprises:
determining, by the processor, whether the request is a threat;
responsive to a determination that the request is a threat, prompting, by the processor, the requester for verification;
determining, by the processor, whether a live agent is used;
responsive to a determination that the live agent is used, engaging, by the processor, the live agent;
determining, by the processor, whether the verification was successful; and
responsive to a determination that the verification was not successful, blocking, by the processor, the request.

6. The method of claim 5, further comprising:
responsive to a determination that the live agent is not used, prompting, by the requester for required information;
determining, by the processor, whether the verification was successful; and
responsive to a determination that the verification was successful, re-evaluating, by the processor, the request.

7. The method of claim 1, wherein escalating the requester using escalation increments further comprises:
creating, by the processor, an escalation request using a selected one of the escalation increments;
determining, by the processor, whether the escalation request was successful; and
responsive to a determination that the escalation request was successful, re-evaluating, by the processor, the request; and
responsive to a determination that the escalation request was not successful, blocking, the request.

8. A computer program product for resolving a detected threat, the computer program product comprising a computer readable medium having a computer executable program code stored thereon, wherein the computer executable program code, when executed on a computing device, causes the computing device to:
receive a request from a requester to form a received request;
extract statistics associated with the received request to form extracted statistics;
perform rules validation for the received request using the extracted statistics;
determine whether the request is a threat; and
responsive to a determination that the request is a threat, escalate the requester using escalation increments, wherein the computer executable program code for using escalation increments further causes the computing device to increase user identity and validation requirements through one of percolating to a next user level and direct entry to a user level.

9. The computer program product of claim 8, wherein the computer executable program code to extract statistics associated with the received request further causes the computing device to:
track session information to form tracked session information; and
store the tracked session information in an active session and identifiers database.

10. The computer program product of claim 8, wherein the computer executable program code to perform rules validation further causes the computing device to:
select rules associated with an escalation increment to form selected rules; and
apply the selected rules to the received request.

11. The computer program product of claim 9, wherein the computer executable program code determine whether the request is a threat further causes the computing device to:
compare the tracked session information with predefined criteria associated with a user level of an escalation increment to form a comparison; and
determine whether the comparison exceeds a predefined threshold.

12. The computer program product of claim 8, wherein the computer executable program code to escalate the requester using escalation increments further causes the computing device to:
determine whether the request is a threat;
responsive to a determination that the request is a threat, prompt the requester for verification;
determine whether a live agent is used;
responsive to a determination that the live agent is used, engage the live agent;
determine whether the verification was successful;
responsive to a determination that the verification was not successful, block the request.

13. The computer program product of claim 12, wherein the computer executable program code further causes the computing device to:
responsive to a determination that the live agent is not used prompt the requester for required information;
determine whether the verification was successful; and
responsive to a determination that the verification was successful, re-evaluate the request.

14. The computer program product of claim 8, wherein the computer executable program code to escalate the requester using escalation increments further causes the computing device to:
create an escalation request using a selected one of the escalation increments;
determine whether the escalation request was successful; and
responsive to a determination that the escalation request was successful, re-evaluate request; and
responsive to a determination that the escalation request was not successful, block the request.

15. An apparatus for resolving a detected threat, the apparatus comprising:
a processor; and
a memory coupled to the processor, wherein the memory comprises instructions which, when executed by the processor, cause the processor to:
receive a request from a requester to form a received request;
extract statistics associated with the received request to form extracted statistics;
perform rules validation for the received request using the extracted statistics;
determine whether the request is a threat; and
responsive to a determination that the request is a threat, escalate the requester using escalation increments by increasing user identity and validation requirements through one of percolating to a next user level and direct entry to a user level.

16. The apparatus of claim 15, wherein the instructions to extract statistics associated with the received request further causes the processor to:
track session information to form tracked session information; and
store the tracked session information in an active session and identifiers database.

17. The apparatus of claim 15, wherein the instructions perform further causes the processor to:
select rules associated with an escalation increment to form selected rules; and
apply the selected rules to the received request.

18. The apparatus of claim 16, wherein the instructions to determine further causes the processor to:
compare the tracked session information with predefined criteria associated with a user level of an escalation increment to form a comparison; and
determine whether the comparison exceeds a predefined threshold.

19. The apparatus of claim 15, wherein the instructions to escalate the requester using escalation increments further causes the processor to:
determine whether the request is a threat;
responsive to a determination that the request is a threat; prompt the requester for verification;
determine whether a live agent is used;
responsive to a determination that the live agent is used, engage the live agent;
determine whether the verification was successful; and
responsive to a determination that the verification was not successful, block the request.

20. The apparatus of claim 19, wherein the instructions further causes the processor to:
responsive to a determination that the live agent is not used, prompt the requester for required information;
determine whether the verification was successful; and
responsive to a determination that the verification was successful, re-evaluate the request.

21. The apparatus of claim 15, wherein the instructions to escalate the requester using escalation increments further causes the processor to:
create an escalation request using a selected one of the escalation increments;
determine whether the escalation request was successful; and
responsive to a determination that the escalation request was successful, re-evaluate the request; and
responsive to a determination that the escalation request was not successful, block the request.
